(19) United States
(12) Patent Application Publication
(10) Pub. No.: US 2007/0018788 A1
(43) Pub. Date: Jan. 25, 2007

(54) Unlock control device

(75) Inventor: Satoru Taniguchi, Anjo-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/449,804

(22) Filed: Jun. 9, 2006

(30) Foreign Application Priority Data
Jul. 20, 2005 (JP) 2005-210048

(51) Int. Cl. G05B 23/00

(52) U.S. Cl. 340/5.64; 340/5.72; 70/277

(57) ABSTRACT

An unlock control device has an unlocking mechanism to unlock an opening and closing member on the assumption that a radio signal transmitted by a legitimate portable transmitter has been received. A key cylinder selectively takes one of an unlock position and a lock position by an insertion of a legitimate key, the unlock position for permitting unlocking the opening and closing member, the lock position for limiting unlocking the opening and closing member. A position detector detects a selected position of the key cylinder. A control part limits unlocking by the unlocking mechanism when the selected position detected by the position detector is the lock position.

### BACKGROUND OF THE INVENTION

1. Field of the Invention

The present invention relates to unlock control devices and, more particularly, to an unlock control device capable of unlocking by a radio signal and unlocking using a key cylinder.

2. Description of the Related Art

There is known a vehicle trunk unlocking device that disables unlocking a vehicle trunk by operating a remote controller of a keyless system that locks and unlocks a vehicle door (for example, refer to Patent Document 1). The vehicle trunk unlocking apparatus disables unlocking a vehicle trunk achieved by an operation of an opener switch, which is located in a vehicle compartment for unlocking the vehicle trunk, by invalidating an operation of the opener switch at a time of locking a vehicle door by an operation of the remote controller. That is, even if a third person enters a vehicle compartment by breaking a window glass and operates the opener switch to open a vehicle trunk, the vehicle trunk cannot be unlocked since the unlocking is disabled, thereby improving an antitheft performance of the vehicle trunk.

Patent Document 1: Japanese Laid-Open Patent Application No. 9-217533

However, according to the above-mentioned conventional antitheft technique, if an owner of a vehicle entrusts a third person with the vehicle together with a remote controller and if the third person has a malicious intent, it is possible for the third person to enter the vehicle compartment using the remote controller and also unlock the vehicle trunk.

### SUMMARY OF THE INVENTION

It is a general object of the present invention to provide an improved and useful unlock control device in which the above-mentioned problems are eliminated.

A more specific object of the present invention is to provide an unlock control device which can prevent unlocking of an opening and closing member such as a trunk lid so as to improve a security function.

In order to achieve the above-mentioned objects, there is provided according to the present invention

There is provided according to one aspect of the present invention an unlock control device having an unlocking mechanism to unlock an opening and closing member on the assumption that a radio signal transmitted by a legitimate portable transmitter has been received, the unlock control device comprising: a key cylinder that selectively takes one of an unlock position and a lock position by an insertion of a legitimate key, the unlock position for permitting unlocking the opening and closing member, the lock position for limiting unlocking the opening and closing member; a position detector that detects a selected position of said key cylinder; and a control part that limits unlocking by said unlocking mechanism when the selected position detected by said position detector is said lock position.

According to an embodiment of the above-mentioned invention, unlocking of the opening and closing member by the legitimate portable transmitter can be limited by switching to the unlock position by using a legitimate key. Accordingly, when locking the opening and closing member, if a mechanical sub key for emergency use or the like is held separately from a main key (the legitimate portable transmitter) after switching the key cylinder to the lock position using the mechanical sub key, the opening and closing member cannot be unlocked even if a third person illegally obtained the main key, which is usually used and convenient, or a third person temporarily given the main key for moving a vehicle at a hotel or the like attempts to unlock the opening and closing member.

Additionally, there is provided according to another aspect of the present invention an unlock control device comprising: a locking mechanism capable of locking a trunk lid by an operation switch provided in a vehicle compartment being operated; and a key cylinder provided outside said vehicle compartment, the key cylinder selectively taking one of an unlock position and a lock position by an insertion of a legitimate key, the unlock position for permitting unlocking the trunk lid, the lock position for limiting unlocking the trunk lid, wherein an unlock control for unlocking the trunk lid and a vehicle door is permitted on the assumption that a radio signal transmitted by a legitimate portable transmitter has been received, irrespective of a selected position of the key cylinder, and wherein the unlock control device further comprising: a position detector that detects the selected position of the key cylinder; and a control part that limits the unlock control for unlocking the trunk lid when the selected position detected by the position detector is the unlock position.

According to an embodiment of the above-mentioned invention, unlocking of the trunk lid by the legitimate portable transmitter can be limited by switching the cylinder key to the lock position by using the legitimate key. Accordingly, when temporarily giving a main key (the legitimate portable transmitter) usually used to a substitute driver (such as a bellboy of a hotel) together with the vehicle at a valet parking of a hotel or a restaurant, the owner of the vehicle may hold the sub key after switching the key cylinder to the lock position by using a sub key (legitimate key) such as an emergency key, the substitute driver, who has the portable transmitter but does not have the sub key, can open a vehicle door and enter the vehicle, but the substitute driver cannot unlock the trunk lid by the operation switch in the vehicle compartment and also cannot unlock the trunk lid in a wireless manner using the main key.

Other objects, features and advantages of the present invention will become more apparent from the following detailed description when read in conjunction with the accompanying drawings.

### BRIEF DESCRIPTION OF THE DRAWINGS

FIG. 1 is an illustration of an unlock control device according to a first embodiment of the present invention, which is equipped in a vehicle;

FIG. 2 is an illustration of a key cylinder which can selectively set whether to permit or not permit unlocking a trunk lid;

FIG. 3 is a flowchart of an operation of the unlock control device shown in FIG. 1;

FIG. 4 is an illustration of an unlock control device according to a second embodiment of the present invention, which is equipped in a vehicle; and

FIG. 5 is an illustration of an unlock control device according to a third embodiment of the present invention, which is equipped in a vehicle.

### DETAILED DESCRIPTION OF THE PREFERRED EMBODIMENTS

A description will be given below, with reference to the drawings, of embodiments according to the present invention. In the following description, a trunk lid of a vehicle will be explained as a specific example of an opening and closing member. An unlock control device according to the present invention is a device for unlocking a trunk lid by receiving a radio signal transmitted by a portable type remote controller. The remote controller is given an ID code, and a transmitter for transmitting the ID code through a radio frequency is incorporated in the remote controller. If the remote controller is carried by putting it in a pocket or a bag, one can unlock a trunk lid by grasping a door outside handle, which is equipped with an electrostatic type touch sensor, or pressing a trunk open button provided in a vehicle compartment. It should be noted that establishment of a biometrics condition (authentication using a live body) may be added to unlocking conditions so as to improve a security performance.

That is, the unlock control device equipped in the vehicle acquires an ID code stored in a remote controller which is carried by a user (an owner of the vehicle or a person given the remote controller from the owner), and determines whether or not the acquired ID code matches an ID code provided to the vehicle so as to permit or not permit unlocking a trunk lid. If the ID code transmitted from the remote controller does not match the ID code of the vehicle, it is determined that the remote controller is not a legitimate remote controller, and, thus, unlocking of the trunk lid is not permitted.

It should be noted that the remote controller may be provided with a function to unlock a vehicle door for a user to get on and get off from the vehicle by transmitting a radio signal in addition to the unlocking function of the trunk lid. Or, an engine starting function such as an ignition key function may be provided to the remote controller. Additionally, the remote controller is provided with transmission buttons such as a LOCK button and an UNLOCK button, and a radio frequency may be transmitted when the transmission buttons are pressed.

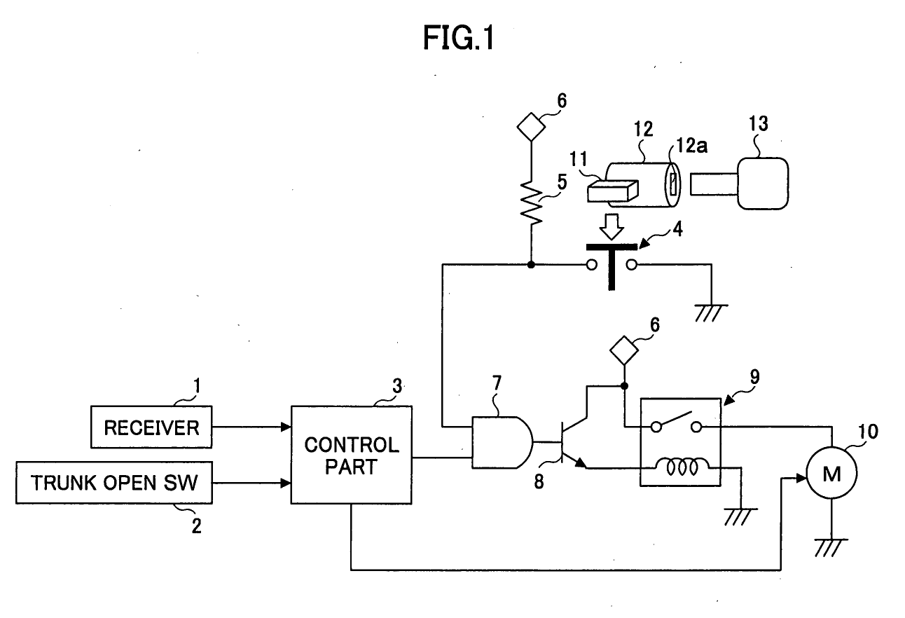

FIG. 1 is an illustration of an unlock control device according to a first embodiment of the present invention, which is equipped in a vehicle.

In the unlock control device shown in FIG. 1, a receiver 1 receives an ID code radio-transmitted from the above-mentioned remote controller, and sends the received ID code to a control part 3. A trunk open switch (SW) 2 is for detecting a grasp of a door outside handle or an operation of a trunk open button. Thus, the control part 3 is capable of recognizing an intention of a user who intends to make an opening or closing operation of a trunk lid.

It should be noted that a fingerprint reading device may be attached to the trunk open SW 2 so that the trunk open SW is turned ON if a fingerprint read by a fingerprint sensor provided to a vehicle door matches a finger print of a registered user.

The control part 3 determines whether to permit or not permit a trunk open motor 10, which enables an automatic opening and closing of the trunk lid based on a result of reception of the receiver 1 and a result of detection of the trunk open SW 2, and outputs an operation signal based on a result of the determination.

Moreover, a key cylinder 12 is provided in a rear part of the vehicle or the trunk lid so that the user can lock or unlock the trunk lid from outside the vehicle using a mechanical sub key 13 for emergency. The key cylinder 12 has a cancel lever 11 mentioned later.

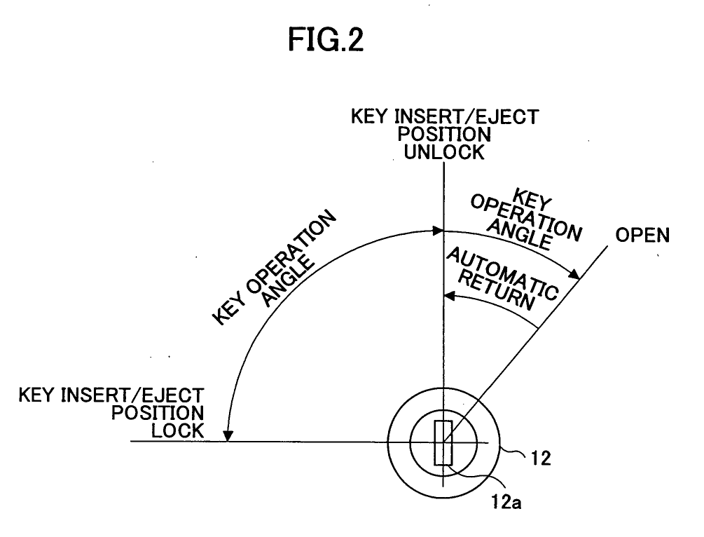

FIG. 2 is an illustration of a key cylinder which can selectively set whether to permit or not permit unlocking a trunk lid. In order to unlock the trunk lid using the sub key, the user inserts the sub key 13 into a key slot 12a and turns the sub key 13 in a rightward direction to an OPEN position. Then, a switch mechanism, which mechanically locks the trunk lid, is operated to unlock and open the trunk lid. When the user release a force to turn the sub key 13, the sub key 13 automatically returns to an UNLOCK position.

On the other hand, if the user inserts the sub key 13 into the key slot 12a and turns the sub key 13 in a leftward direction, an opening operation (unlocking) of the trunk lid from a vehicle compartment is invalidated. For example, in a locking mechanism that unlocks and permits opening a trunk lid by operating an operation switch (trunk opener) provided in a vehicle compartment, when the sub key 13 is turned in a leftward direction to the LOCK position, the trunk lid cannot open even if the trunk opener in the vehicle compartment is operated.

If the locking mechanism is a well-known cable mechanism, a cable link thereof is detached by the cancel lever 11 which is interlocked with the turning operation of the sub key 13 to the LOCK position. According to the cable link being detached, the trunk lid cannot be opened even if the trunk opener in the vehicle compartment is operated. That is, if a third person who does not have the sub key 13 operates the trunk opener, the trunk lid cannot be opened, thereby maintaining security of the trunk. It should be noted that the switch mechanism that can selectively set whether to permit or not permit a trunk lid is disclosed in Japanese Laid-Open Patent Application No. 11-30065, and a description thereof will be omitted.

When performing unlocking of the trunk lid in wireless manner by using a legitimate remote controller, the position of the key cylinder 12 is shifted to the UNLOCK position if a mechanical operation of the switch mechanism to unlock by the trunk open motor 10 is the same as the mechanical operation of the switch mechanism to unlock by an insertion of the key to the key cylinder 12 even if the unlocking operation has been invalidated by the key cylinder 12 being set to the LOCK position (more specifically, even if the cable link has been detached mechanically). Accordingly, if a third person operates the legitimate remote controller, the trunk lid is opened even if the unlocking operation by the trunk opener is invalidated, and, therefore, security of the trunk cannot be maintained.

Thus, the unlock control device according to the present embodiment is provided with a trunk cancel switch (SW) 4, which detects the LOCK and UNLOCK positions of the cylinder 12 to stop an operation of the trunk open motor 10. In FIG. 1, the trunk cancel SW 4 is operated by the cancel lever 11, which is interlocked with a turning operation to the LOCK position (in FIG. 1, the trunk cancel switch 4 is put in an ON state). Thereby, a low-level signal (Lo-level) is input to an AND circuit 7. On the other hand, the trunk cancel SW 4 dose not operate at positions other than the LOCK position (in FIG. 1, the trunk cancel switch 4 is put in an OFF (OPEN) state), and a high-level signal (Hi-level) is input to the AND circuit 7. It should be noted that a resistor 5 and a power source 6, which are connected to contact points of the trunk cancel SW 4, are provided for fixing the Hi-level when the trunk cancel SW 4 is in the OFF state.

Therefore, when the Lo-level is input to the AND circuit 7 by the trunk cancel SW 4, a transistor 8 shown in FIG. 1 does not activate even if the control part 3 outputs the Hi-level operation signal for actuating the trunk open motor 10 to the AND circuit 7. Thereby, a path necessary for driving the trunk open motor 10 is interrupted by a relay 9.

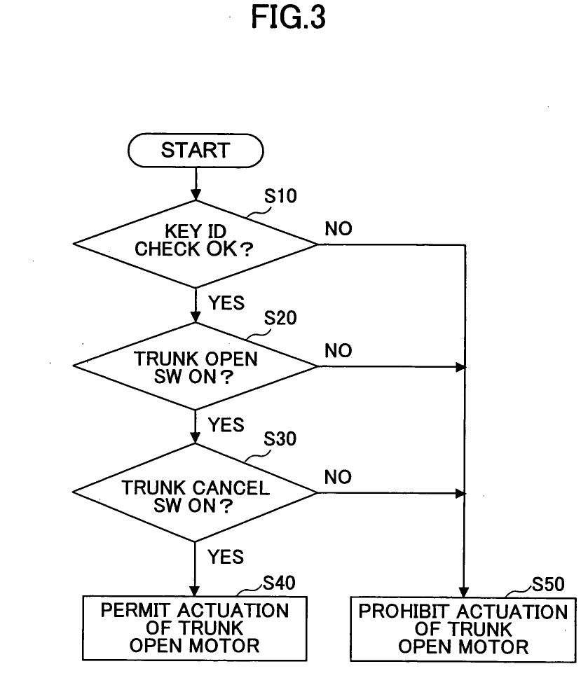

FIG. 3 is a flowchart showing an example of operation of the unlock control device according to the present embodiment. The control part 3 compares the ID code, which has been transmitted by the remote controller and received by the receiver 1, with the ID code, which is registered previously in the vehicle (step S10). If the ID codes do not match each other, the control part 3 outputs the Lo-level operation signal, and, thereby, an actuation of the trunk open motor 10 is prohibited by the interruption of the path by the relay 9 (step S50). On the other hand, if the ID codes match each other, the control part checks whether or not the trunk open SW 2 is ON (step S20). If the trunk open SW 2 is OFF, the control part 3 outputs the Lo-level operation signal, and, thereby, an actuation of the trunk open motor 10 is prohibited by the interruption of the path by the relay 9 (step S50). On the other hand, if the trunk open SW 2 is ON, the control part 3 outputs the Hi-level operation signal for actuating the trunk open motor 10. At this time, if the trunk cancel SW 4 is turned ON (NO of step S30), the Lo-level is input to the AND circuit 7, and, thus, an actuation of the trunk open motor 10 is prohibited by the interruption of the path by the relay 9 (step S50). On the other hand, if the trunk cancel SW 4 is turned OFF (YES of step S30), the Hi-level is input to the AND circuit 7. Thus, an actuation of the trunk open motor 10 is permitted, and the trunk open motor 10 can be actuated.

Therefore, when entrusting the remote controller to a substitute driver (such as a bellboy of a hotel) together with the vehicle at a valet parking of a hotel or a restaurant, the owner of the vehicle may hold the sub key 13 after switching the key cylinder 12 to the LOCK position by using the sub key 13. Accordingly, the substitute driver, who has the remote controller but does not have the sub key 13, can open a vehicle door and enter the vehicle, but the substitute driver cannot unlock the trunk by the trunk opener in the vehicle compartment and also cannot unlock the trunk in a wireless manner using the remote controller.

Although the preferred embodiment was described, the present invention is not limited to the above-mentioned embodiment.

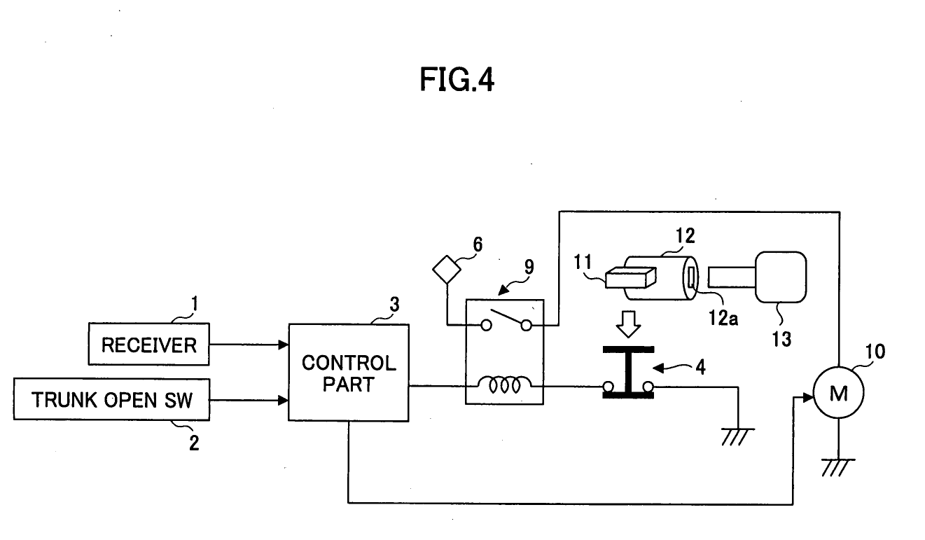

A description will now be given, with reference to FIG. 4, of a second embodiment of the present invention. FIG. 4 is an illustration of an unlock control device according to the second embodiment of the present invention when the unlock control device is equipped in a vehicle. In FIG. 4, parts that are the same as the parts shown in FIG. 1 are given the same reference numerals, and descriptions thereof will be omitted.

When the controller 3 permits an actuation of the trunk open motor 10 based on a result of reception of the receiver 1 and a result of detection by the trunk open SW 2, the control part 3 outputs a Hi-level permission signal. In the case of FIG. 4, the trunk cancel SW 4 is put in an ON state (as shown in FIG. 4) if the key cylinder 12 is at the UNLOCK position. Thus, if the sub key 13 is inserted into the key slot 12a and turned to the left to the LOCK position, the trunk cancel SW 4 is put in an OFF state (OPEN state).

Therefore, when the trunk cancel SW 4 is ON, it becomes possible to cause the relay 9 to pass an electric current therethrough. Thus, the control part 3 can actuate the trunk open motor 10 by sending the Hi-level permission signal. However, when the trunk cancel SW 4 is OFF, it is not possible to cause the relay 9 to pass an electric current therethrough. Thus, the trunk open motor 10 cannot be actuated even if the control part 3 sends the Hi-level permission signal.

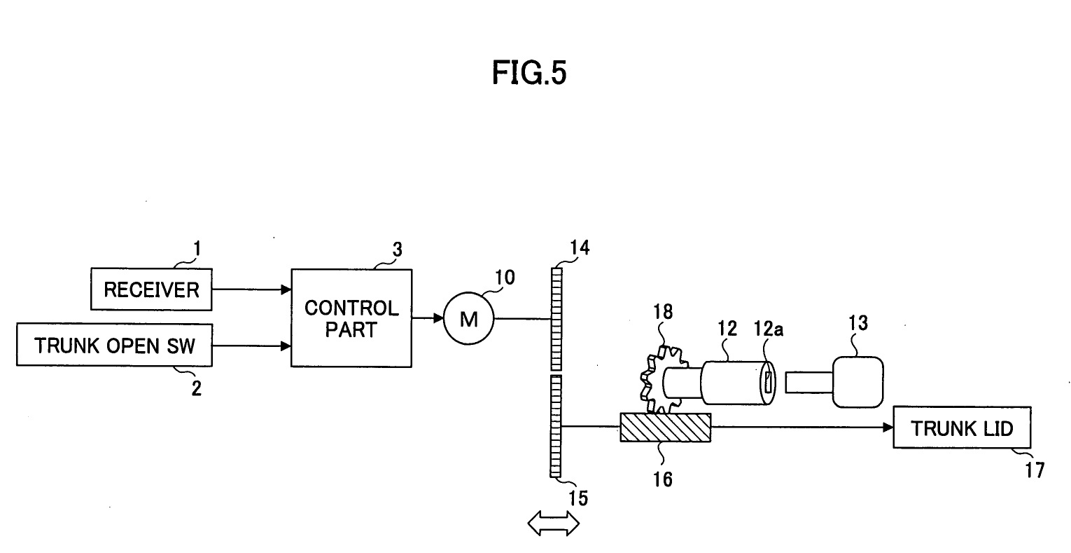

A description will now be given, with reference to FIG. 5, of a third embodiment of the present invention. FIG. 5 is an illustration of an unlock control device according to the third embodiment of the present invention when the unlock control device is equipped in a vehicle. In FIG. 5, parts that are the same as the parts shown in FIG. 1 are given the same reference numerals, and descriptions thereof will be omitted.

When the control part 3 permits an actuation of the trunk open motor 10 based on a result of reception of the receiver 1 and a result of detection by the trunk open SW 2, the control part 3 outputs a drive signal for actuating the trunk open motor 10. The rotation output of the trunk open motor 10 actuates a trunk lid 17 to open or close via gears 14 and 15. Additionally, a worm gear, which includes a worm wheel 18 and a worm 16 engaged with each other, is provided between the trunk open motor 10 and the trunk lid 17. In the case of FIG. 5, the gears 14 and 15 are engaged with each other when the key cylinder 12 is at the UNLOCK position so that the rotation output of the trunk open motor 10 is transmitted to the trunk lid 17 (as shown in FIG. 5). However, if the sub key 13 is inserted into the key slot 12a and turned to the left to the LOCK position, the worm gear operates so that the worm 16 moves in an axial direction of the worm 16 (a leftward or rightward direction in the figure), and, thereby, the gears 14 and 15 are disengaged with each other. Accordingly, the rotation output of the trunk open motor 10 is not transmitted to the trunk lid 17, which prohibits the trunk lid 17 from being opened.

The present invention is not limited to the specifically disclosed embodiments, and variations and modifications may be made without departing from the scope of the present invention.

The present application is based on Japanese priority application No. 2005-210048 filed Jul. 20, 2005, the enter contents of which are hereby incorporated herein by reference.

What is claimed is:

1. An unlock control device having an unlocking mechanism to unlock an opening and closing member on the assumption that a radio signal transmitted by a legitimate portable transmitter has been received, the unlock control device comprising:
a key cylinder that selectively takes one of an unlock position and a lock position by an insertion of a legitimate key, the unlock position for permitting unlocking said opening and closing member, the lock position for limiting unlocking said opening and closing member;
a position detector that detects a selected position of said key cylinder; and
a control part that limits unlocking by said unlocking mechanism when the selected position detected by said position detector is said lock position.

2. The unlock control device as claimed in claim 1, further comprising a drive mechanism for unlocking said opening and closing member, the drive mechanism being controlled by said control part.

3. The unlock control device as claimed in claim 2, wherein said control part limits an unlocking operation of said drive mechanism.

4. The unlock control device as claimed in claim 3, wherein said control part interrupts a transmission path of said unlocking operation.

5. The unlock control device as claimed in claim 2, wherein said unlocking mechanism includes:
a motor for operating said opening and closing member; and
an electric circuit having a relay that selectively opens or closes an electric path connected to said motor based on a signal supplied by said control part and a signal generated by said key cylinder.

6. The unlock control device as claimed in claim 2, wherein said unlocking mechanism includes:
a motor for operating said opening and closing member; and
a plurality of gears that transmits a power output from said motor to said opening and closing member,
wherein the plurality of gears include a pair of a worm and a worm wheel being engaged with each other when said key cylinder is at said unlock position, and disengaged with each other when said key cylinder is at said lock position.

7. The unlock control device as claimed in claim 1, wherein said opening and closing member is a trunk lid of a vehicle.

8. An unlock control device comprising:
a locking mechanism capable of locking a trunk lid by an operation switch provided in a vehicle compartment being operated; and
a key cylinder provided outside said vehicle compartment, the key cylinder selectively taking one of an unlock position and a lock position by an insertion of a legitimate key, the unlock position for permitting unlocking said trunk lid, the lock position for limiting unlocking said trunk lid,
wherein an unlock control for unlocking said trunk lid and a vehicle door is permitted on the assumption that a radio signal transmitted by a legitimate portable transmitter has been received, irrespective of a selected position of said key cylinder, and wherein said unlock control device further comprising:
a position detector that detects the selected position of said key cylinder; and
a control part that limits said unlock control for unlocking said trunk lid when the selected position detected by said position detector is said unlock position.
